(19) United States
(12) Patent Application Publication
(10) Pub. No.: US 2018/0160133 A1
(43) Pub. Date: Jun. 7, 2018

(54) REALTIME RECORDING OF GESTURES AND/OR VOICE TO MODIFY ANIMATIONS

(71) Applicant: GOOGLE LLC, Mountain View, CA (US)

(72) Inventors: Tim Gleason, Jersey City, NJ (US); Jon Bedard, New York, NY (US); Darwin Yamamoto, Brooklyn, NY (US); Ian MacGillivray, New York, NY (US)

(21) Appl. No.: 15/830,936

(22) Filed: Dec. 4, 2017

Related U.S. Application Data
(60) Provisional application No. 62/430,175, filed on Dec. 5, 2016.

(51) Int. Cl. H04N 19/423; H04L 29/08; H04N 5/222

(52) U.S. Cl. CPC H04N 19/423; H04L 67/02; H04N 5/2224; H04L 67/12

(57) ABSTRACT

Techniques of compressing a number of frames of a presentation generated in a virtual environment per time period. Along these lines, the animations in each chapter of a presentation is expressed in a number of frames. Depending on the memory capacity of the device generating the presentation in the virtual environment, the device may package the frames into sections having a fixed amount of memory or covering a given amount of presentation time. The device may them compress each of these sections one at a time. Upon compression, the device may transmit a compressed section to a remote storage device.

### CROSS REFERENCE TO RELATED APPLICATION

This application claims the benefit of U.S. Provisional Application No. 62/430,175, filed Dec. 5, 2016, the disclosure of which is incorporated herein by reference in its entirety.

### TECHNICAL FIELD

This description relates to presentations in virtual reality environments.

### BACKGROUND

Conventional approaches to creating presentations including movies and animations include adding elements such as text, graphics, and animation to electronic slides in presentation software. In some instances, all added elements may be stored in local or cloud storage.

### SUMMARY

In one general aspect, a method can include generating, by processing circuitry of the VR computer, a first set of presentation frames representing a first portion of a presentation in the virtual environment over a first time interval and a second set of presentation frames representing a second portion of the presentation over a second time interval, each of the first set of presentation frames and the second set of presentation frames including a set of virtual objects, each of the set of virtual objects of that presentation frame having a respective state. The method can also include performing a first compression operation on the first set of presentation frames to produce first compressed presentation data, the first set of presentation frames being stored locally in a memory of the VR computer during the first compression operation. The method can further include transferring the first compressed presentation data to a remote storage device remote from the VR computer and removing the first set of presentation frames from the memory of the VR computer. The method can further include performing a second compression operation on the second set of presentation frames to produce second compressed data and transferring the second compressed presentation data to the remote storage device.

The details of one or more implementations are set forth in the accompanying drawings and the description below. Other features will be apparent from the description and drawings, and from the claims.

### BRIEF DESCRIPTION OF THE DRAWINGS

FIG. 1 is a diagram that illustrates an example electronic environment in which improved techniques described herein may be implemented.

FIG. 2 is a flow chart that illustrates an example method of implementing the improved techniques as shown in FIG. 1.

FIG. 3 is a diagram of an example virtual environment in which a presentation is generated according to the improved techniques shown in FIG. 1.

FIG. 4 is a diagram of example metadata according to the improved techniques shown in FIG. 1.

FIG. 5 is a flow chart illustrating an example method of implementing the improved techniques shown in FIG. 1.

FIG. 6 illustrates an example of a computer device and a mobile computer device that can be used with circuits described here.

FIG. 7 is a diagram depicting an example VR head-mounted display (HMD).

FIGS. 8A, 8B, and 8C are diagrams depicting the example VR HMD and controller.

### DETAILED DESCRIPTION

The above-described conventional approaches to creating presentations are limited to a non-immersive, two-dimensional viewing environment. Creating presentations in a three-dimensional, immersive virtual environment may involve many more elements that are more complex and data-intensive than the two-dimensional elements. Although virtual environment is described throughout in this description, the concepts described herein can be applied to an augmented reality environment with a combination of virtual objects and real-world physical objects. Storing such complex elements for three-dimensional, immersive virtual environments presents problems of storing and accessing the elements as needed for a presentation. It is noted that presentation can include any animation generated for an audience, including movies and interactive discussions.

Along these lines, consider a presentation in an immersive virtual environment. The presentation can include one or more chapters or sections. In a chapter, an avatar of a presenter may tell a story to a virtual audience (e.g., an audience of avatars) by manipulating objects within the virtual environment. The presenter may move to a new chapter by, for example, performing a gesture. Each chapter may include animations of hundreds of objects through the virtual environment. Each of these objects and movements, as well as the virtual environment, has a very large amount of data that would be transmitted to and from devices of the users watching the presentation. The very large amount of data may create storage and transmission problems, especially if the devices are mobile devices that have small amounts of memory.

In contrast to the conventional approaches to creating presentations that do not provide a way to store the plethora of data produced from the objects and their animations within the chapters of the presentation, improved techniques of creating presentations involve compressing a number of frames of a presentation generated in a virtual environment per time period. Along these lines, the animations in each chapter of a presentation are expressed in a number of frames. Depending on the memory capacity of the device generating the presentation in the virtual environment, the device may package the frames into sections having a fixed amount of memory or covering a given amount of presentation time. The device may them compress each of these sections one at a time. Upon compression, the device may transmit a compressed section to a remote storage device. Advantageously, compressed sections of a presentation (or chapter of a presentation) can be stored relatively inexpensively in remote storage and temporarily on local storage. With proper metadata, these sections can be stored and recalled in any order required.

In some implementations, the improved techniques include a method to record a 3D presentation that includes providing a virtual record button by which a presenter, in a preset scene, is may record a chapter of a presentation. A chapter in a 3D presentation may be comparable to a slide in a 2D experience. The presenter's head and hands movements may be preserved for playback, so that viewers see a natural avatar presenting to them. The users speech will be preserved for playback also.

The user will be capable of using a number of very natural gestures to cause objects to fade in or out of the scene, or otherwise draw attention to them. Prime examples here include swiping up to cause an object to rise from the floor; pointing to cause a ghost of an object to become visible to viewers; and button presses aimed at objects to cause spotlights to appear. Each of these commands activated by a gesture will be recorded along with the movement and voice to create a cohesive chapter of a presentation, and many such chapters may be recorded in the same manner.

In a first Scene Builder prototype, the ability to record the transition of objects in the scene with basic gestures, and to record the presenters voice as this happened were implemented. In a second Scene Builder prototype the ability to record the presenters head-and-hands and display them back as an avatar to the viewer of a presentation, as well as the ability to record granular movements of objects in the scene (e.g. when picked up by the presenter) in addition to triggering pre-recorded macros were added.

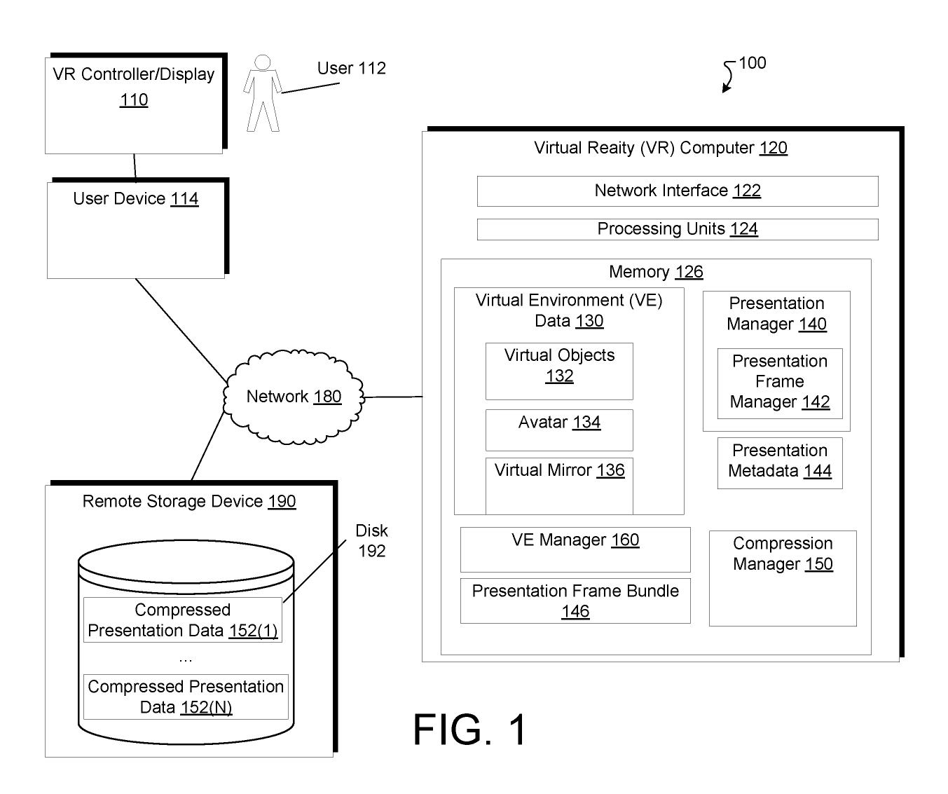

FIG. 1 is a diagram that illustrates an example electronic environment 100 in which the above-described improved techniques may be implemented. As shown, in FIG. 1, the electronic environment 100 includes a user 112 immersed in a VR environment via a VR Controller 110 powered by a user device 114. The electronic environment 100 also includes a VR computer 120 and a network 150.

The VR controller 110 may take the form of a head-mounted display (HMD) which is worn by the user 112 to provide an immersive virtual environment or an augmented reality environment. In the example electronic environment 100, the user 112 that wears the VR controller 110 holds a user device, i.e., user device 114. The user device 114 may be, for example, a smartphone, a controller, a joystick, or another portable handheld electronic device(s) that may be paired with, and communicate with, the VR controller 110 for interaction in the immersive virtual environment. The user device 114 may be operably coupled with, or paired with the VR controller 110 via, for example, a wired connection, or a wireless connection such as, for example, a WiFi or Bluetooth connection. This pairing, or operable coupling, of the user device 114 and the VR controller 110 may provide for communication between the user device 114 and the VR controller 110 and the exchange of data between the user device 114 and the VR controller 110. This may allow the user device 114 to function as a controller in communication with the VR controller 110 for interacting in the immersive virtual environment. That is, a manipulation of the user device 114, such as, for example, a beam or ray emitted by the user device 114 and directed to a virtual object or feature for selection, and/or an input received on a touch surface of the user device 114, and/or a movement of the user device 114, may be translated into a corresponding selection, or movement, or other type of interaction, in the immersive virtual environment or an augmented reality environment provided by the VR controller 110.

The VR computer 120 is configured to generate and play back chapters of a presentation. As illustrated in FIG. 1, the VR computer 120 is implemented as a computer system that is in communication with the user device 114 over the network 180. In some implementations, the VR computer 120 may be included within the user device 114.

The VR computer 120 includes a network interface 122, one or more processing units 124, and memory 126. The network interface 122 includes, for example, Ethernet adaptors, Token Ring adaptors, and the like, for converting electronic and/or optical signals received from the network 150 to electronic form for use by the VR server computer 120. The set of processing units 124 include one or more processing chips and/or assemblies. The memory 126 includes both volatile memory (e.g., RAM) and non-volatile memory, such as one or more ROMs, disk drives, solid state drives, and the like. The set of processing units 124 and the memory 126 together form control circuitry, which is configured and arranged to carry out various methods and functions as described herein.

In some embodiments, one or more of the components of the VR computer 120 can be, or can include processors (e.g., processing units 124) configured to process instructions stored in the memory 126. Examples of such instructions as depicted in FIG. 1 include a Virtual Environment (VE) manager 160, a presentation manager 140, and a compression manager 150. Further, as illustrated in FIG. 1, the memory 126 is configured to store various data, which is described with respect to the respective managers that use such data.

The VE manager 160 is configured to generate and process the virtual environment, represented in the VR server computer 120 as VE data 130. For example, the VE manager 130 may be configured to generate three-dimensional virtual objects 132 used in a presentation such as charts, characters, balls, wands, and the like. Further, the VE manager may also generate avatars for (e.g., representing) each user including the presenter. The presenter may use a virtual mirror 136 to see how the presenter appears to the other users as the presenter is presenting each chapter of the presentation.

The presentation manager 140 includes a presentation frame manager 142 and is configured to generate and process the chapters of the presentation for replay to users within the virtual environment. As part of processing the chapters of the presentation, the presentation frame manager 142 is configured to bundle the various presentation sections according to the memory capacity of the user device 114.

In some implementations, the presentation manager 140 is further configured to generate presentation metadata 144. When the presentation sections are arranged in a sequence to form a chapter of the presentation, the presentation metadata 144 may be included with each presentation section and describes that section's place within the sequence. In some further implementations, the presentation metadata 144 may be included with each presentation frame and may describe the various objects 132 in that frame as well as the object states (e.g., object position within the virtual environment, the size of the object, and the transparence of the object).

The presentation manager 142 is further configured to play (e.g., play back, execute) the presentation in the virtual environment. Along these lines, the presentation manager 142 may be configured to extract the compressed presentation data 152(1), . . . , 152(N) in the correct order (i.e., determined from the metadata 144), send to the compression manager 150 for decompression, and then present the animations of the objects in the presentation frames in the virtual environment.

The compression manager 150 is configured to compress sections of a presentation and transmit the compressed sections 152(1), . . . , 152(N) to remote storage device 190. The compression manager 150 is further configured to decompress the compressed sections. The compression manager 150 may use any standard compression algorithms to accomplish the compression of the presentation sections.

The remote storage 190 is remote from the VR computer 120 (e.g., connected to the VR computer 120 via a network and not co-located with the VR computer 120) and is configured to receive and store the compressed sections 152(1), . . . , 152(N). In some implementations, the remote storage 190 includes a storage disk 192. In some implementations, the storage disk 192 is part of an array of storage disks. In some implementations, the array of storage disks is a RAID array.

The components (e.g., modules, processing units 124) of the VR computer 120 can be configured to operate based on one or more platforms (e.g., one or more similar or different platforms) that can include one or more types of hardware, software, firmware, operating systems, runtime libraries, and/or so forth. In some implementations, the components of the VR server computer 120 120 can be configured to operate within a cluster of devices (e.g., a server farm). In such an implementation, the functionality and processing of the components of the VR server computer 120 can be distributed to several devices of the cluster of devices.

The components of the VR server computer 120 can be, or can include, any type of hardware and/or software configured to process attributes. In some implementations, one or more portions of the components shown in the components of the VR server computer 120 in FIG. 1 can be, or can include, a hardware-based module (e.g., a digital signal processor (DSP), a field programmable gate array (FPGA), a memory), a firmware module, and/or a software-based module (e.g., a module of computer code, a set of computer-readable instructions that can be executed at a computer). For example, in some implementations, one or more portions of the components of the VR server computer 120 can be, or can include, a software module configured for execution by at least one processor (not shown). In some implementations, the functionality of the components can be included in different modules and/or different components than those shown in FIG. 1.

Although not shown, in some implementations, the components of the user device 120 (or portions thereof) can be configured to operate within, for example, a data center (e.g., a cloud computing environment), a computer system, one or more server/host devices, and/or so forth. In some implementations, the components of the VR server computer 120 (or portions thereof) can be configured to operate within a network. Thus, the components of the VR server computer 120 (or portions thereof) can be configured to function within various types of network environments that can include one or more devices and/or one or more server devices. For example, the network can be, or can include, a local area network (LAN), a wide area network (WAN), and/or so forth. The network can be, or can include, a wireless network and/or wireless network implemented using, for example, gateway devices, bridges, switches, and/or so forth. The network can include one or more segments and/or can have portions based on various protocols such as Internet Protocol (IP) and/or a proprietary protocol. The network can include at least a portion of the Internet.

In some embodiments, one or more of the components of the VR server computer 120 can be, or can include, processors configured to process instructions stored in a memory. For example, a VE communications manager 160 (and/or a portion thereof) and a VE conflict resolution manager 170 can be a combination of a processor and a memory configured to execute instructions related to a process to implement one or more functions.

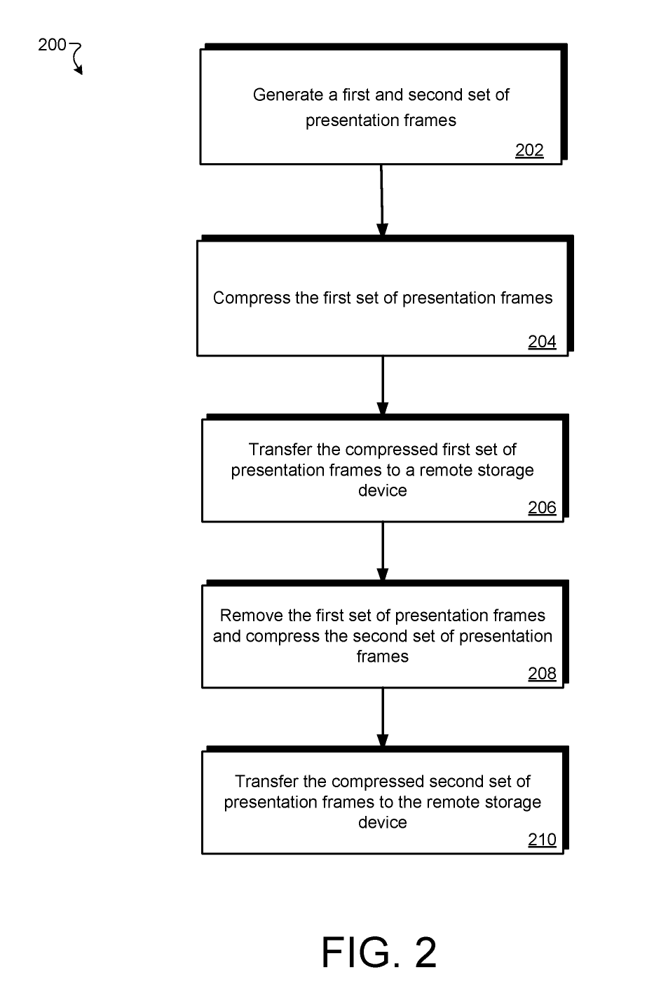

In some implementations, the memory 126 can be any type of memory such as a random-access memory, a disk drive memory, flash memory, and/or so forth. In some implementations, the memory 126 can be implemented as more than one memory component (e.g., more than one RAM component or disk drive memory) associated with the components of the VR server computer 120. In some implementations, the memory 126 can be a database memory. In some implementations, the memory 126 can be, or can include, a non-local memory. For example, the memory 126 can be, or can include, a memory shared by multiple devices (not shown). In some implementations, the memory 126 can be associated with a server device (not shown) within a network and configured to serve the components of the VR server computer 120. As illustrated in FIG. 2, the memory 126 is configured to store various data, including VE data 130, a user avatar 150, and user identifiers 154.

FIG. 2 is a flow chart depicting an example method 200 of. The method 200 may be performed by software constructs described in connection with FIG. 1, which reside in memory 126 of the VR server computer 120 and are run by the set of processing units 124.

At 202, the VR computer 120 generates a first set of presentation frames representing a first portion of a presentation in the virtual environment over a first time interval and a second set of presentation frames representing a second portion of the presentation over a second time interval. Each of the first set of presentation frames and the second set of presentation frames includes a set of virtual objects. Each of the set of virtual objects of that presentation frame has a respective state.

At 204, the VR computer 120 performs a first compression operation on the first set of presentation frames to produce first compressed presentation data 152(1). The first set of presentation frames is stored locally (e.g., in a memory co-located with the VR computer 120) in a memory of the VR computer during the first compression operation.

At 206, the VR computer 120 transfers the first compressed presentation data to a remote storage device 190 remote from the VR computer 120.

At 208, the VR computer 120 removes the first set of presentation frames (assuming that the compression was not performed in place) and performs a second compression operation on the second set of presentation frames to produce second compressed presentation data 152(2).

At 210, the VR computer 120 transfers the second compressed presentation data to the remote storage device 190.

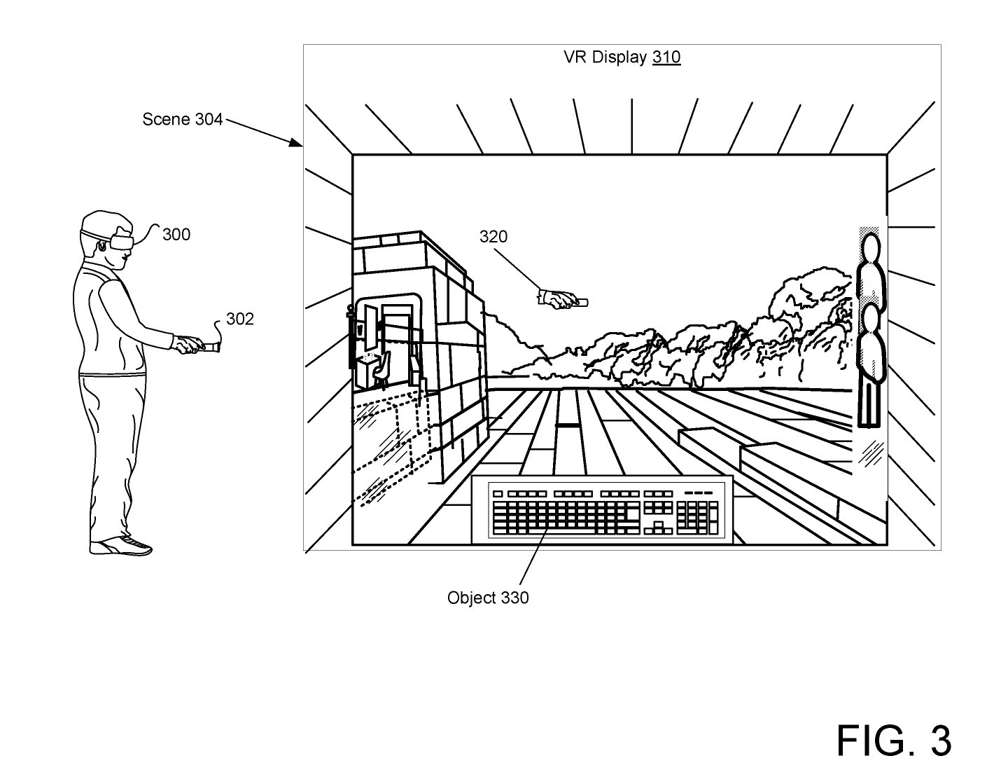

FIG. 3 is a diagram illustrating an example scene 304 of a presentation within a virtual environment. As shown in FIG. 3, a user 300 with a controller 302 looks via his head-mounted display (HMD) 310 at his representation 320 (here, an image of his controller) and an object 330 (here, a keyboard) in the scene 304.

The user 300, via his avatar 320, may move or manipulate the object 330. At any instant, the object 330 is located at a location within the virtual environment. Further, during the presentation the object 330 at some point may be introduced into or removed from the virtual environment. In this case, it is desired that the object 330 not appear suddenly as that would detract from the immersive experience of other users observing the presentation. Rather, the object 330 may either fade in/out or grow from/shrink to nothing over several frames. Accordingly, the object 330 may be assigned states such as size and transparence.

Further, during an animation generated by the user 300, the VR computer 120 may capture this animation by sampling the animation at some specified sample rate. The frames generated at the sample rate may serve as keyframes, i.e., frames in which objects are rendered. During playback of the presentation, the VR computer 120 may provide a continuous animation between the keyframes by interpolating the objects' positions, sizes, and transparences between frames.

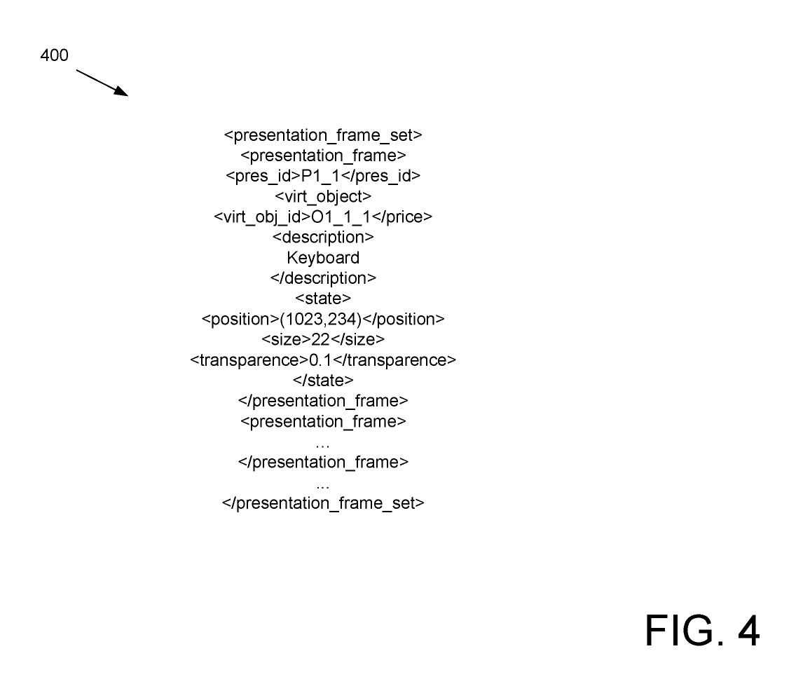

FIG. 4 illustrates an example metadata 400 that describes a presentation frame set that defines a presentation. In this example, the metadata is expressed using an XML script. Nevertheless, other scripting forms may be used.

In this example, the presentation frame set contains multiple presentation frames. Each presentation frame has an identifier (which indicates an ordering in a sequence), virtual object identifiers and respective descriptors, and a state. The state of an object includes values of positions, sizes, and transparences for each frame.

Because each frame and frame set is identified with respect to its order in a sequence, the presentation frame sets do not have to be formed, compressed, and stored in order. This allows for a simple editing process: during editing, presentation frames will be compressed and saved out of order. By maintaining the metadata associated with each frame and frame set during an edit of frames in a frame set, the order of the presentation is unaffected by subsequent edits of frames.

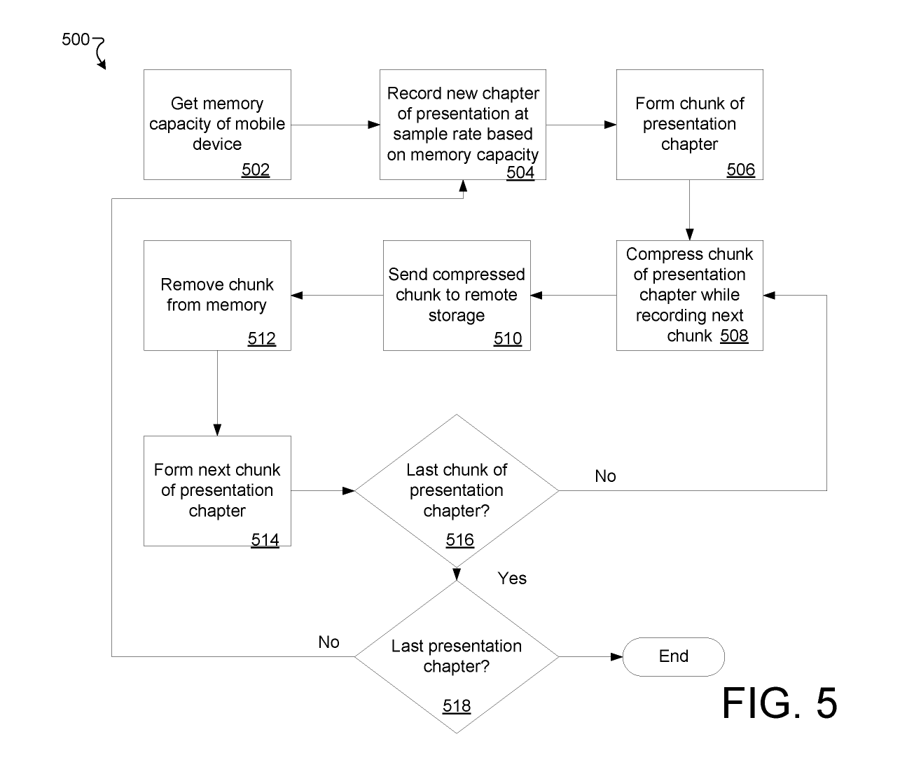

FIG. 5 illustrates an example process 500 of creating a presentation in a virtual environment. The process 500 may be performed by software constructs described in connection with FIG. 1, which reside in memory 126 of the VR server computer 120 and are run by the set of processing units 124.

At 502, the VR computer 120 acquires the current capacity of its memory 126. For example, if the VR computer 120 is contained within the user device 114, a mobile device, the VR computer may attempt to obtain the capacity of the system cache.

At 504, the VR computer 120 records the animations in a chapter of a presentation at a sample rate based on the memory capacity.

At 506, the VR computer 120 forms a chunk of the presentation chapter, i.e., a set of presentation frames, with the number of frames being based on, e.g., an amount of time covered by the section, the memory capacity of the VR computer 120, and the amount of data in each presentation frame.

At 508, the VR computer 120 performs a compression operation on the section of the presentation chapter to produce a compressed section. Meanwhile, the VR computer 120 records the next set of presentation frames.

At 510, the VR computer 120 sends the compressed section to remote storage, remote from the VR computer 120.

At 512, the VR computer 120 removes the uncompressed section from the local storage if the compression was not performed in place.

At 514, the VR computer 120 forms another section of the presentation chapter in a similar fashion as in 506.

At 516, if this other section is the last section of the presentation chapter, then the process 500 goes to 518. Otherwise, the process 500 goes back to 508.

At 518, if this presentation chapter is the final chapter of the presentation, then the process 500 ends. Otherwise, the process 500 goes back to 504.

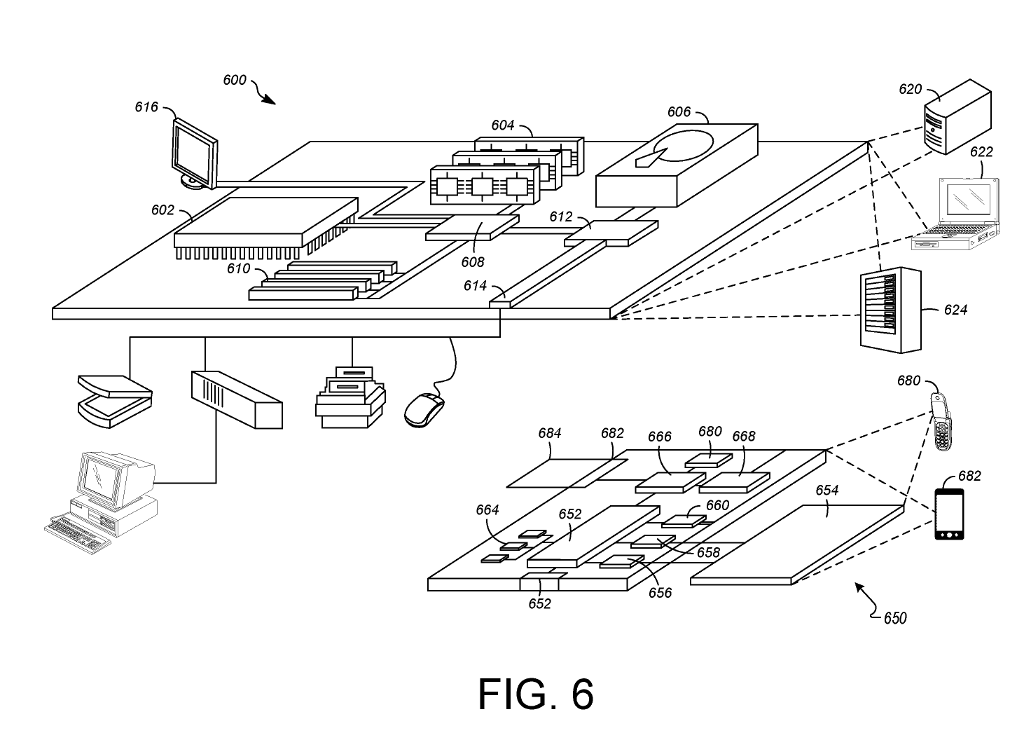

FIG. 6 illustrates an example of a generic computer device 600 and a generic mobile computer device 650, which may be used with the techniques described here.

As shown in FIG. 6, computing device 600 is intended to represent various forms of digital computers, such as laptops, desktops, workstations, personal digital assistants, servers, blade servers, mainframes, and other appropriate computers. Computing device 650 is intended to represent various forms of mobile devices, such as personal digital assistants, cellular telephones, smart phones, and other similar computing devices. The components shown here, their connections and relationships, and their functions, are meant to be exemplary only, and are not meant to limit implementations of the inventions described and/or claimed in this document.

Computing device 600 includes a processor 602, memory 604, a storage device 606, a high-speed interface 608 connecting to memory 604 and high-speed expansion ports 610, and a low speed interface 612 connecting to low speed bus 614 and storage device 606. Each of the components 602, 604, 606, 608, 610, and 612, are interconnected using various busses, and may be mounted on a common motherboard or in other manners as appropriate. The processor 602 can process instructions for execution within the computing device 600, including instructions stored in the memory 604 or on the storage device 606 to display graphical information for a GUI on an external input/output device, such as display 616 coupled to high speed interface 608. In other implementations, multiple processors and/or multiple buses may be used, as appropriate, along with multiple memories and types of memory. Also, multiple computing devices 600 may be connected, with each device providing portions of the necessary operations (e.g., as a server bank, a group of blade servers, or a multi-processor system).

The memory 604 stores information within the computing device 600. In one implementation, the memory 604 is a volatile memory unit or units. In another implementation, the memory 604 is a non-volatile memory unit or units. The memory 604 may also be another form of computer-readable medium, such as a magnetic or optical disk.

The storage device 606 is capable of providing mass storage for the computing device 600. In one implementation, the storage device 606 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 604, the storage device 606, or memory on processor 602.

The high speed controller 608 manages bandwidth-intensive operations for the computing device 500, while the low speed controller 612 manages lower bandwidth-intensive operations. Such allocation of functions is exemplary only. In one implementation, the high-speed controller 608 is coupled to memory 604, display 616 (e.g., through a graphics processor or accelerator), and to high-speed expansion ports 610, which may accept various expansion cards (not shown). In the implementation, low-speed controller 612 is coupled to storage device 506 and low-speed expansion port 614. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 600 may be implemented in a number of different forms, as shown in the figure. For example, it may be implemented as a standard server 620, or multiple times in a group of such servers. It may also be implemented as part of a rack server system 624. In addition, it may be implemented in a personal computer such as a laptop computer 622. Alternatively, components from computing device 600 may be combined with other components in a mobile device (not shown), such as device 650. Each of such devices may contain one or more of computing device 600, 650, and an entire system may be made up of multiple computing devices 600, 650 communicating with each other.

Computing device 650 includes a processor 652, memory 664, an input/output device such as a display 654, a communication interface 666, and a transceiver 668, among other components. The device 650 may also be provided with a storage device, such as a microdrive or other device, to provide additional storage. Each of the components 650, 652, 664, 654, 666, and 668, are interconnected using various buses, and several of the components may be mounted on a common motherboard or in other manners as appropriate.

The processor 652 can execute instructions within the computing device 650, including instructions stored in the memory 664. The processor may be implemented as a chipset of chips that include separate and multiple analog and digital processors. The processor may provide, for example, for coordination of the other components of the device 650, such as control of user interfaces, applications run by device 650, and wireless communication by device 650.

Processor 652 may communicate with a user through control interface 658 and display interface 656 coupled to a display 654. The display 654 may be, for example, a TFT LCD (Thin-Film-Transistor Liquid Crystal Display) or an OLED (Organic Light Emitting Diode) display, or other appropriate display technology. The display interface 656 may comprise appropriate circuitry for driving the display 654 to present graphical and other information to a user. The control interface 658 may receive commands from a user and convert them for submission to the processor 652. In addition, an external interface 662 may be provided in communication with processor 652, so as to enable near area communication of device 650 with other devices. External interface 662 may provide, for example, for wired communication in some implementations, or for wireless communication in other implementations, and multiple interfaces may also be used.

The memory 664 stores information within the computing device 650. The memory 664 can be implemented as one or more of a computer-readable medium or media, a volatile memory unit or units, or a non-volatile memory unit or units. Expansion memory 674 may also be provided and connected to device 650 through expansion interface 672, which may include, for example, a SIMM (Single In Line Memory Module) card interface. Such expansion memory 674 may provide extra storage space for device 650, or may also store applications or other information for device 650. Specifically, expansion memory 674 may include instructions to carry out or supplement the processes described above, and may include secure information also. Thus, for example, expansion memory 674 may be provided as a security module for device 650, and may be programmed with instructions that permit secure use of device 650. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 664, expansion memory 674, or memory on processor 652, that may be received, for example, over transceiver 668 or external interface 662.

Device 650 may communicate wirelessly through communication interface 666, which may include digital signal processing circuitry where necessary. Communication interface 666 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 668. In addition, short-range communication may occur, such as using a Bluetooth, WiFi, or other such transceiver (not shown). In addition, GPS (Global Positioning System) receiver module 670 may provide additional navigation- and location-related wireless data to device 650, which may be used as appropriate by applications running on device 650.

Device 650 may also communicate audibly using audio codec 660, which may receive spoken information from a user and convert it to usable digital information. Audio codec 660 may likewise generate audible sound for a user, such as through a speaker, e.g., in a handset of device 650. Such sound may include sound from voice telephone calls, may include recorded sound (e.g., voice messages, music files, etc.) and may also include sound generated by applications operating on device 650.

The computing device 650 may be implemented in a number of different forms, as shown in the figure. For example, it may be implemented as a cellular telephone 680. It may also be implemented as part of a smart phone 682, personal digital assistant, or other similar mobile device.

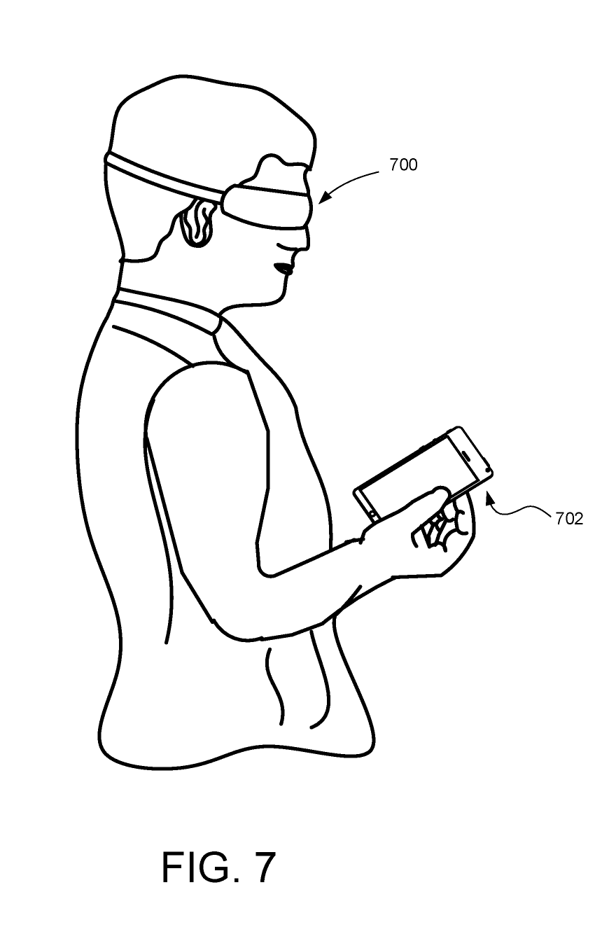

FIG. 7 illustrates an example implementation of a head-mounted display as shown in FIGS. 3 and 5. In FIG. 7, a user wearing an HMD 700 is holding a portable handheld electronic device 702. The handheld electronic device 702 may be, for example, a smartphone, a controller, a joystick, or another portable handheld electronic device(s) that may be paired with, and communicate with, the HMD 700 for interaction in the immersive virtual environment generated by the HMD 700. The handheld electronic device 702 may be operably coupled with, or paired with the HMD 700 via, for example, a wired connection, or a wireless connection such as, for example, a WiFi or Bluetooth connection. This pairing, or operable coupling, of the handheld electronic device 702 and the HMD 700 may provide for communication between the handheld electronic device 702 and the HMD 700 and the exchange of data between the handheld electronic device 702 and the HMD 700. This may allow the handheld electronic device 602 to function as a controller in communication with the HMD 700 for interacting in the immersive virtual environment or an augmented reality environment generated by the HMD 700. That is, a manipulation of the handheld electronic device 702, such as, for example, a beam or ray emitted by the handheld electronic device 702 and directed to a virtual object or feature for selection, and/or an input received on a touch surface of the handheld electronic device 702, and/or a movement of the handheld electronic device 702, may be translated into a corresponding selection, or movement, or other type of interaction, in the immersive virtual environment or an augmented reality environment generated by the HMD 700. For example, the HMD 700, together with the handheld electronic device 702, may generate a virtual environment as described above, and the handheld electronic device 702 may be manipulated to effect a change in scale, or perspective, of the user relative to the virtual features in the virtual environment as described above.

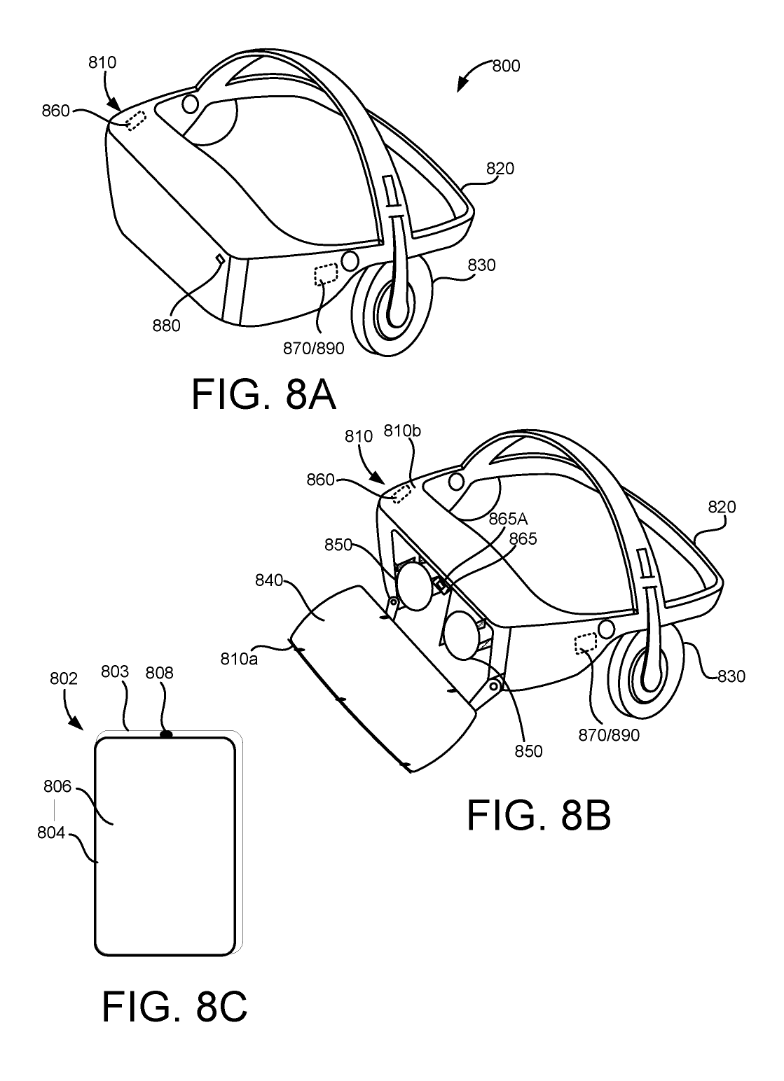

FIGS. 8A and 8B are perspective views of an example HMD, such as, for example, the HMD 700 worn by the user in FIG. 7, and FIG. 8C illustrates an example handheld electronic device, such as, for example, the handheld electronic device 702 shown in FIG. 7.

The handheld electronic device 802 may include a housing 803 in which internal components of the device 802 are received, and a user interface 804 on an outside of the housing 803, accessible to the user. The user interface 804 may include a touch sensitive surface 806 configured to receive user touch inputs. The user interface 804 may also include other components for manipulation by the user such as, for example, actuation buttons, knobs, joysticks and the like. In some implementations, at least a portion of the user interface 804 may be configured as a touchscreen, with that portion of the user interface 804 being configured to display user interface items to the user, and also to receive touch inputs from the user on the touch sensitive surface 806. The handheld electronic device 802 may also include a light source 808 configured to selectively emit light, for example, a beam or ray, through a port in the housing 803, for example, in response to a user input received at the user interface 804.

The HMD 800 may include a housing 810 coupled to a frame 820, with an audio output device 830 including, for example, speakers mounted in headphones, also be coupled to the frame 820. In FIG. 8B, a front portion 810a of the housing 810 is rotated away from a base portion 810b of the housing 810 so that some of the components received in the housing 810 are visible. A display 840 may be mounted on an interior facing side of the front portion 810a of the housing 810. Lenses 850 may be mounted in the housing 810, between the user's eyes and the display 840 when the front portion 810a is in the closed position against the base portion 810b of the housing 810. In some implementations, the HMD 800 may include a sensing system 860 including various sensors and a control system 870 including a processor 890 and various control system devices to facilitate operation of the HMD 800.

In some implementations, the HMD 800 may include a camera 880 to capture still and moving images. The images captured by the camera 880 may be used to help track a physical position of the user and/or the handheld electronic device 802 in the real world, or physical environment relative to the virtual environment, and/or may be displayed to the user on the display 840 in a pass through mode, allowing the user to temporarily leave the virtual environment and return to the physical environment without removing the HMD 800 or otherwise changing the configuration of the HMD 800 to move the housing 810 out of the line of sight of the user.

In some implementations, the HMD 800 may include a gaze tracking device 865 to detect and track an eye gaze of the user. The gaze tracking device 865 may include, for example, an image sensor 865A, or multiple image sensors 865A, to capture images of the user's eyes, for example, a particular portion of the user's eyes, such as, for example, the pupil, to detect, and track direction and movement of, the user's gaze. In some implementations, the HMD 800 may be configured so that the detected gaze is processed as a user input to be translated into a corresponding interaction in the immersive virtual experience.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of embodiments have been described. Nevertheless, it will be understood that various modifications may be made without departing from the spirit and scope of the specification.

It will also be understood that when an element is referred to as being on, connected to, electrically connected to, coupled to, or electrically coupled to another element, it may be directly on, connected or coupled to the other element, or one or more intervening elements may be present. In contrast, when an element is referred to as being directly on, directly connected to or directly coupled to another element, there are no intervening elements present. Although the terms directly on, directly connected to, or directly coupled to may not be used throughout the detailed description, elements that are shown as being directly on, directly connected or directly coupled can be referred to as such. The claims of the application may be amended to recite exemplary relationships described in the specification or shown in the figures.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

What is claimed is:

1. A method of producing a presentation within a virtual environment generated by a virtual reality (VR) computer, comprising:
generating, by processing circuitry of the VR computer, a first set of presentation frames representing a first portion of a presentation in the virtual environment over a first time interval and a second set of presentation frames representing a second portion of the presentation over a second time interval, each of the first set of presentation frames and the second set of presentation frames including a set of virtual objects, each of the set of virtual objects of that presentation frame having a respective state;
performing a first compression operation on the first set of presentation frames to produce first compressed presentation data, the first set of presentation frames being stored locally in a memory of the VR computer during the first compression operation;
transferring the first compressed presentation data to a remote storage device remote from the VR computer;
removing the first set of presentation frames from the memory of the VR computer;
performing a second compression operation on the second set of presentation frames to produce second compressed data; and
transferring the second compressed presentation data to the remote storage device.

2. The method as in claim 1, further comprising:
retrieving the first compressed data and the second compressed data from the remote storage device;
performing a decompression operation on the first compressed data and the second compressed data to produce the first set of presentation frames and the second set of presentation frames; and
generating the first portion and the second portion of the presentation in the virtual environment from the first set of presentation frames and the second set of presentation frames.

3. The method as in claim 2, wherein each of the set of virtual objects has a first state in the first set of presentation frames and has a second state in the second set of presentation frames; and
wherein generating the first portion and the second portion of the presentation in the virtual environment includes performing an interpolation operation on each of the virtual objects to produce a set of intermediate states between the first state and the second state of that virtual object.

4. The method as in claim 2, wherein each of the first set of presentation frames and the second set of presentation frames includes respective metadata, the metadata including sequencing information indicating a time within the presentation at which a portion of the presentation represented by that set of presentation frames is presented; and
wherein generating the first portion and the second portion of the presentation in the virtual environment includes:
reading the sequencing information of the metadata; and
arranging the first set of presentation frames and the second set of presentation frames in the presentation according to the sequencing information.

5. The method as in claim 2, wherein each of the presentation frames of the first set of presentation frames includes respective metadata, the metadata including sequencing information within the first set of presentation frames; and
wherein generating the first portion and the second portion of the presentation in the virtual environment includes:
reading the sequencing information of the metadata; and
arranging the first set of presentation frames according to the sequencing information.

6. The method as in claim 1, wherein generating the first set of presentation frames includes:
generating a first presentation frame of the first set of presentation frames that includes a plurality of virtual objects, each of the plurality of virtual objects having a respective first state;
generating a second presentation frame of the first set of presentation frames that includes the plurality of virtual objects, each of the plurality of virtual objects having a respective second state;
removing, from the second presentation frame, virtual objects of the plurality of objects for which the second state matches the first state.

7. The method as in claim 1, wherein the VR computer includes a mobile device; and
wherein generating the first set of presentation frames includes:
transmitting a request to the mobile device for an amount of memory available for performing compression operations;
receiving a message from the mobile device indicating an amount of memory available for performing the compression operations; and
producing the first set of presentation frames based on the memory available for performing compression operations.

8. The method as in claim 1, further comprising, after transferring the first compressed presentation data to the remote storage device remote from the VR computer;
performing an editing operation on the first set of presentation frames to produce an edited first set of presentation frames;
performing a compression operation on the edited first set of presentation frames to produce edited first compressed presentation data, the edited first set of presentation frames being stored locally in a memory of the VR computer during the compression operation;
transferring the edited first compressed presentation data to the remote storage device; and
removing the first compressed presentation data from the remote storage device.

9. The method as in claim 1, wherein the state of a virtual object of a presentation frame of the first set of presentation frames includes a position of the virtual object within the virtual environment.

10. The method as in claim 9, wherein the state of the virtual object further includes a size of the virtual object and a transparence of the virtual object.

11. A computer program product comprising a nontransitive storage medium, the computer program product including code that, when executed by processing circuitry of a virtual reality (VR) computer configured to produce a VR environment, causes the processing circuitry to perform a method, the method comprising:
generating a first set of presentation frames representing a first portion of a presentation in the virtual environment over a first time interval and a second set of presentation frames representing a second portion of the presentation over a second time interval, each of the first set of presentation frames and the second set of presentation frames including a set of virtual objects, each of the set of virtual objects of that presentation frame having a respective state;
performing a first compression operation on the first set of presentation frames to produce first compressed presentation data, the first set of presentation frames being stored locally in a memory of the VR computer during the first compression operation;
transferring the first compressed presentation data to a remote storage device remote from the VR computer;
removing the first set of presentation frames from the memory of the VR computer;
performing a second compression operation on the second set of presentation frames to produce second compressed data; and
transferring the second compressed presentation data to the remote storage device.

12. The computer program product as in claim 11, wherein the method further comprises:
retrieving the first compressed data and the second compressed data from the remote storage device;
performing a decompression operation on the first compressed data and the second compressed data to produce the first set of presentation frames and the second set of presentation frames; and
generating the first portion and the second portion of the presentation in the virtual environment from the first set of presentation frames and the second set of presentation frames.

13. The computer program product as in claim 12, wherein each of the set of virtual objects has a first state in the first set of presentation frames and has a second state in the second set of presentation frames; and
wherein generating the first portion and the second portion of the presentation in the virtual environment includes performing an interpolation operation on each of the virtual objects to produce a set of intermediate states between the first state and the second state of that virtual object.

14. The computer program product as in claim 12, wherein each of the first set of presentation frames and the second set of presentation frames includes respective metadata, the metadata including sequencing information indicating a time within the presentation at which a portion of the presentation represented by that set of presentation frames is presented; and
wherein generating the first portion and the second portion of the presentation in the virtual environment includes:
reading the sequencing information of the metadata; and
arranging the first set of presentation frames and the second set of presentation frames in the presentation according to the sequencing information.

15. The computer program product as in claim 12, wherein each of the presentation frames of the first set of presentation frames includes respective metadata, the metadata including sequencing information within the first set of presentation frames; and
wherein generating the first portion and the second portion of the presentation in the virtual environment includes:
reading the sequencing information of the metadata; and
arranging the first set of presentation frames according to the sequencing information.

16. The computer program product as in claim 11, wherein generating the first set of presentation frames includes:
generating a first presentation frame of the first set of presentation frames that includes a plurality of virtual objects, each of the plurality of virtual objects having a respective first state;
generating a second presentation frame of the first set of presentation frames that includes the plurality of virtual objects, each of the plurality of virtual objects having a respective second state;
removing, from the second presentation frame, virtual objects of the plurality of objects for which the second state matches the first state.

17. The computer program product as in claim 11, wherein the VR computer includes a mobile device; and
wherein generating the first set of presentation frames includes:
transmitting a request to the mobile device for an amount of memory available for performing compression operations;
receiving a message from the mobile device indicating an amount of memory available for performing the compression operations; and
producing the first set of presentation frames based on the memory available for performing compression operations.

18. The computer program product as in claim 11, further comprising, after transferring the first compressed presentation data to the remote storage device remote from the VR computer;
performing an editing operation on the first set of presentation frames to produce an edited first set of presentation frames;
performing a compression operation on the edited first set of presentation frames to produce edited first compressed presentation data, the edited first set of presentation frames being stored locally in a memory of the VR computer during the compression operation;
transferring the edited first compressed presentation data to the remote storage device; and
removing the first compressed presentation data from the remote storage device.

19. The computer program product as in claim 11, wherein the state of a virtual object of a presentation frame of the first set of presentation frames includes a position of the virtual object within the virtual environment.

20. An electronic apparatus configured to produce a VR environment, the electronic apparatus comprising:
memory; and
controlling circuitry coupled to the memory, the controlling circuitry being configured to:
generate a first set of presentation frames representing a first portion of a presentation in the virtual environment over a first time interval and a second set of presentation frames representing a second portion of the presentation over a second time interval, each of the first set of presentation frames and the second set of presentation frames including a set of virtual objects, each of the set of virtual objects of that presentation frame having a respective state;
perform a first compression operation on the first set of presentation frames to produce first compressed presentation data, the first set of presentation frames being stored locally in a memory of the VR computer during the first compression operation;
transfer the first compressed presentation data to a remote storage device remote from the VR computer;
remove the first set of presentation frames from the memory of the VR computer;
perform a second compression operation on the second set of presentation frames to produce second compressed data; and
transfer the second compressed presentation data to the remote storage device.
